(19) United States
(12) Patent Application Publication
(10) Pub. No.: US 2024/0311207 A1
(43) Pub. Date: Sep. 19, 2024

(54) SLICE COORDINATION

(71) Applicant: QUALCOMM Incorporated, San Diego, CA (US)

(72) Inventors: Jian LIANG, San Diego, CA (US); Hu YI, San Diego, CA (US); Tao WANG, Sunnyvale, CA (US); Fei XU, San Jose, CA (US); Ruobai FENG, San Diego, CA (US)

(21) Appl. No.: 18/184,381

(22) Filed: Mar. 15, 2023

(51) Int. Cl. G06F 9/50; G06F 9/54

(52) U.S. Cl. CPC G06F 9/5077; G06F 9/5038; G06F 9/5083; G06F 9/544

(57) ABSTRACT

Aspects of the disclosure are directed to coordination. In accordance with one aspect, an apparatus including a plurality of slices, wherein each slice of the plurality of slices is configured for distributed information processing; and a plurality of dedicated databuses, wherein each slice of the plurality of slices is coupled to one of the plurality of dedicated databuses and each slice of the plurality of slices is configured for local coordination for the distributed information processing.

### TECHNICAL FIELD

This disclosure relates generally to the field of coordination, and, in particular, to slice coordination.

### BACKGROUND

Most information processing systems and communication systems have multiple nodes in a distributed system. The multiple nodes include multiple producers of messages and data and multiple consumers of messages and data. In general, some level of coordination and control of the multiple nodes is required to maintain data coherency. That is, as messages and data are updated, it is important to maintain consistency among the multiple nodes. One example of a distributed system is a computing system with multiple processing cores or slices which need to be coordinated. Maintaining data coherency among the multiple processing cores or slices by an efficient coordination scheme are desired in distributed information processing systems.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides an apparatus for executing local coordination. Accordingly, an apparatus including a plurality of slices, wherein each slice of the plurality of slices is configured for distributed information processing; and a plurality of dedicated databuses, wherein each slice of the plurality of slices is coupled to one of the plurality of dedicated databuses and each slice of the plurality of slices is configured for local coordination for the distributed information processing.

In one example, the each slice of the plurality of slices includes a memory unit. In one example, the each slice of the plurality of slices is a processing unit. In one example, the apparatus further includes a plurality of current workload batches. In one example, each of the plurality of current workload batches is stored within the memory unit of the each slice of the plurality of slices.

In one example, each of the plurality of current workload batches is different from another of the plurality of current workload batches. In one example, at least two of the plurality of current workload batches are the same. In one example, the apparatus further includes a plurality of external memory units configured to store a plurality of future workload batches, wherein each of the plurality of slices is associated with one of the plurality of future workload batches.

In one example, the apparatus further includes a plurality of data producers, wherein each of the plurality of data producers is configured to execute a write request in each of the plurality of slices. In one example, the apparatus further includes a plurality of data consumers, wherein each of the plurality of data consumers is configured to execute a read request in each of the plurality of slices.

Another aspect of the disclosure provides a method for implementing slice coordination, the method including executing a write request with local coordination in a first batch of a plurality of batches in each slice of a plurality of slices; setting a local event tag in the first batch of the plurality of batches in the each slice of the plurality of slices; monitoring the write request in the first batch of the plurality of batches in the each slice of the plurality of slices; executing a read request with the local coordination in the first batch of the plurality of batches in the each slice of the plurality of slices after monitoring the write request is completed; and monitoring the read request in the first batch of the plurality of batches in the each slice of the plurality of slices.

In one example, the write request in the each slice of the plurality of slices is executed asynchronously with respect to other slices of the plurality of slices. In one example, the method further includes the each slice of the plurality of slices suppling a local output coordination signal to indicate completion of the execution of a batch in the each slice of the plurality of slices.

In one example, monitoring the write request is performed until all previous write requests in a path are completed. In one example, monitoring the write request is performed until a path has a verified receipt of the local event tag. In one example, monitoring the write request is performed until the write request in the first batch of the plurality of batches is completed. In one example, monitoring the write request is performed until two or more of the following occur: a) all previous write requests in a path are completed; b) the path has a verified receipt of the local event tag; c) the write request in the first batch of the plurality of batches is completed.

In one example, the read request in the each slice of the plurality of slices is executed asynchronously with respect to other slices of the plurality of slices. In one example, monitoring the read request is performed until all previous read requests in a path are completed. In one example, monitoring the read request is performed until a path has a verified receipt of the local event tag. In one example, monitoring the read request is performed until the read request in the first batch of the plurality of batches is completed. In one example, monitoring the read request is performed until two or more of the following occur: a) all previous read requests in a path are completed; b) the path has a verified receipt of the local event tag; c) the read request in the first batch of the plurality of batches is completed.

Another aspect of the disclosure provides an apparatus for implementing slice coordination, the apparatus including means for executing a write request with local coordination in a first batch of a plurality of batches in each slice of a plurality of slices; means for setting a local event tag in the first batch of the plurality of batches in the each slice of the plurality of slices; means for monitoring the write request in the first batch of the plurality of batches in the each slice of the plurality of slices; means for executing a read request with the local coordination in the first batch of the plurality of batches in the each slice of the plurality of slices after monitoring the write request is completed; and means for monitoring the read request in the first batch of the plurality of batches in the each slice of the plurality of slices.

In one example, the means for executing the write request is configured to execute asynchronously with respect to other slices of the plurality of slices, and wherein the means for executing the read request is configured to execute asynchronously with respect to the other slices of the plurality of slices. In one example, the means for monitoring the write request is configured to perform monitoring until one or more of the following occur: a) all previous write requests in a path are completed; b) the path has a verified receipt of the local event tag; c) the write request in the first batch of the plurality of batches is completed. In one example, the means for monitoring the read request is configured to perform monitoring until one or more of the following occur: a) all previous read requests in a path are completed; b) the path has a verified receipt of the local event tag; c) the read request in the first batch of the plurality of batches is completed.

Another aspect of the disclosure provides a non-transitory computer-readable medium storing computer executable code, operable on a device including at least one processor and at least one memory coupled to the at least one processor, wherein the at least one processor is configured to implement slice coordination, the computer executable code including instructions for causing a computer to execute a write request with local coordination in a first batch of a plurality of batches in each slice of a plurality of slices; instructions for causing the computer to set a local event tag in the first batch of the plurality of batches in the each slice of the plurality of slices; instructions for causing the computer to monitor the write request in the first batch of the plurality of batches in the each slice of the plurality of slices; instructions for causing the computer to execute a read request with the local coordination in the first batch of the plurality of batches in the each slice of the plurality of slices after monitoring the write request is completed; and instructions for causing the computer to monitor the read request in the first batch of the plurality of batches in the each slice of the plurality of slices.

In one example, the non-transitory computer-readable medium further includes instructions for causing the computer to execute the write request asynchronously with respect to other slices of the plurality of slices, and to execute the read request asynchronously with respect to the other slices of the plurality of slices. In one example, the non-transitory computer-readable medium further includes instructions for causing the computer to monitor the write request until one or more of the following occur: a) all previous write requests in a path are completed; b) the path has a verified receipt of the local event tag; c) the write request in the first batch of the plurality of batches is completed. In one example, the non-transitory computer-readable medium further includes instructions for causing the computer to monitor the read request until one or more of the following occur: a) all previous read requests in a path are completed; b) the path has a verified receipt of the local event tag; c) the read request in the first batch of the plurality of batches is completed.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates a first example information processing system with a plurality of slices.

FIG. 2 illustrates a second example information processing system with a plurality of slices and global coordination.

FIG. 3 illustrates an example distributed information processing system with a plurality of slices.

FIG. 4 illustrates an example flow diagram for executing local coordination in a distributed information processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

A distributed information processing system, for example, a computing system with multiple slices requires a coordination scheme among a plurality of nodes to ensure data coherency. In one example, a slice is a processing core or subset of a computing system. For example, each slice may have at least one processing unit. In one example, data coherency implies uniformity of shared data among a plurality of nodes such as slices and associated memory units. In one example, the associated memory units may form a memory hierarchy with local memory dedicated to each slice, global memory shared among all slices and other memory units with various degrees of shared access (e.g., a level 2 (L2) cache memory).

In one example, the coordination scheme may operate on a global basis, i.e., over all slices, as a global coordination or global synchronization. In another example, the coordination scheme may operate on a local basis, i.e., on each slice individually, as a local coordination or local synchronization. That is, the coordination scheme may be either a global coordination or a local coordination. For example, a coordination node may be one of the plurality of nodes which enforces data coherency among other nodes which access the same data. In one example, the coordination node may enforce data coherency by controlling a coordination signal or executing state transitions which may be accessible among some nodes of the plurality of nodes. In one example, slice coordination is local coordination.

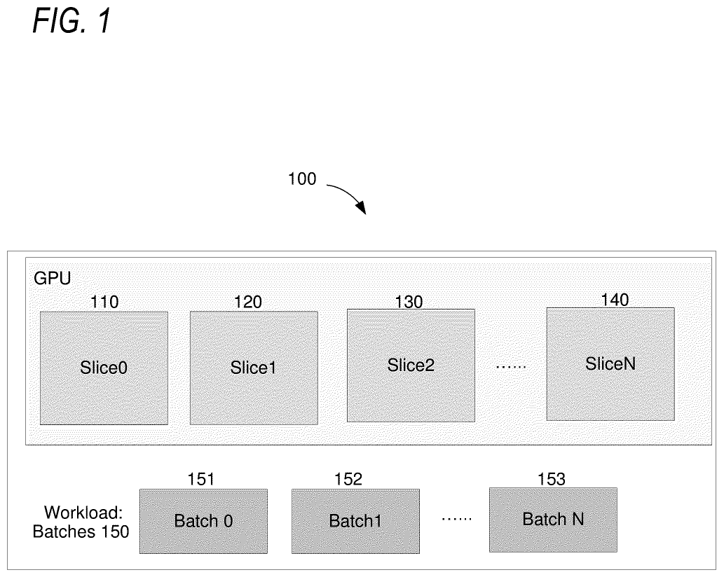

FIG. 1 illustrates a first example information processing system 100 with a plurality of slices. In one example, a slice is a processing unit or core. In one example, the first information processing system 100 may be a graphical processing unit (GPU) or a central processing unit (CPU). In one example, FIG. 1 includes a first slice 110, a second slice 120, a third slice 130 and an Nth slice 140. In general, the first information processing system 100 may have an arbitrary quantity of slices. The plurality of slices may have a plurality of memory units. The plurality of slices may have a plurality of memory units. The plurality of slices may be interconnected by a common databus (not shown) to transport messages and data among the plurality of or slices. In the example of FIG. 1, N quantity of slices are illustrated. One skilled in the art would know that N is any integer quantity.

FIG. 1 also illustrates a plurality of workload batches 150 such as a first batch 151, a second batch 152, an Nth batch 153, etc. In one example, a workload batch or batch is a subset of a workload. In one example, the batch is a sequence of operations which may be executed by a slice. In the example of FIG. 1, N quantity of batches are illustrated. One skilled in the art would know that N is any integer quantity.

In one example, in the first information processing system 100, an input may be self-generated. In one example, the first information processing system 100 includes a plurality of data producers and a plurality of data consumers. For example, the first information processing system 100 may execute the workload with a plurality of batches. In one example, the data producer is a processing unit with software algorithm configured to generate data. In one example, the data producer executes a write request (i.e., a request to write data into a memory unit. In one example, the data consumer is a processing unit with software algorithm configured to read data. In one example, the data producer executes a read request (i.e., a request to read data into a memory unit.

In one example, a first data consumer which is operating on a current batch (e.g., batch N) may need to read in data which is produced from a previous batch (e.g., batch N−1). In one example, the first information processing system 100 may require a coordination scheme to maintain data coherency and to avoid a read-after-write hazard. In one example, the coordination scheme may be global coordination.

In one example, an event tag may be part of the sequence of operations as a discrete message or token to facilitate coordination among the plurality of nodes in the distributed information processing system. For example, if the coordination scheme is global coordination, a global event tag may be used as a coordination message or token. For example, if the coordination scheme is local coordination, a local event tag may be used as a coordination message.

In one example, global coordination may insert a global event tag in the sequence of operations to ensure that all data producers have written data into a target cache memory, buffer memory or main memory prior to any data consumer commencing a read operation on the sequence of operations.

In one example, global coordination executed by a data producer may execute a write request sequence as follows:
{write request in batch0->global event tag->write request in batch1}.

In one example, global coordination executed by a data consumer may execute a read request sequence as follows:
{read request in batch0->global event tag->read request in batch1}.

In one example, when a coordination node (e.g., L2 cache memory) receives the global event tag, it may push back all subsequent request from a common path until the following conditions are met:
1. All previous requests in the common path are completed.
2. The global event tag is received in other paths within the same slice and requests in those other paths are completed.
3. The global event tag is received in other paths in other slices and requests in those other paths are completed.

In one example, requests in a path are completed when all write data are visible in cache memory and all read requests get data returned.

In one example, for the first information processing system 100, a data path may be partitioned into a plurality of lanes or slices. For example, different slices may operate on different batches. In one example, the coordination of the first information processing system 100 may stall all slices and introduce a significant performance impact. For example, a slice running ahead must wait for a slice running behind to complete (i.e., a large bubble is introduced in execution). In one example, for a large-scale information processing system, performance overhead may increase.

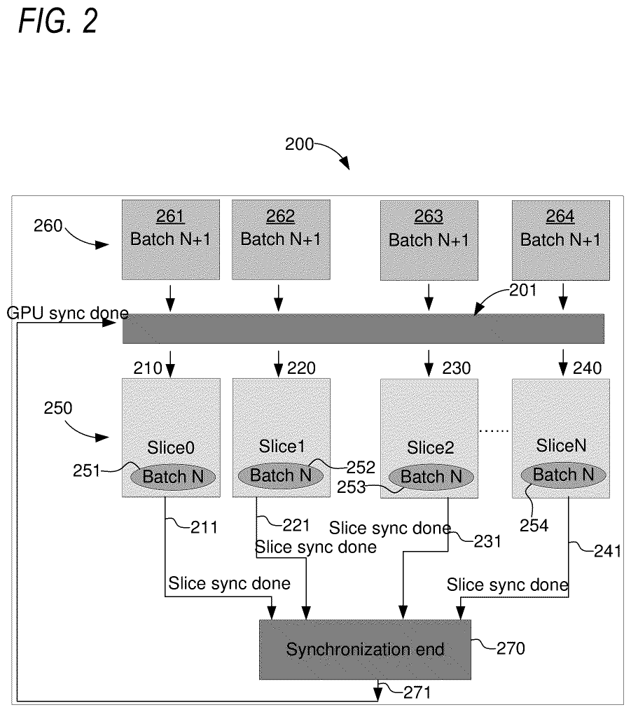

FIG. 2 illustrates a second example information processing system 200 with a plurality of slices and global coordination. In one example, the plurality of slices includes a first slice 210, a second slice 220, a third slice 230, an Nth slice 240, etc. In the example of FIG. 2, N quantity of slices are illustrated. One skilled in the art would know that N is any integer quantity. In general, the second information processing system 200 may have an arbitrary quantity of slices. The plurality of slices may be interconnected by a common databus 201 to transport messages and data among the plurality of or slices.

FIG. 2 also illustrates a plurality of current workload batches 250 including a first current batch 251, a second current batch 252, a third current batch 253, an Nth current batch 254. In the example of FIG. 2, N quantity of current batches are illustrated. One skilled in the art would know that N is any integer quantity.

For example, the first slice 210 is operating with the first current batch 251, the second slice 220 is operating with the second current batch 252, the third slice 230 is operating with the third current batch 253, the Nth slice 240 is operating with the Nth current batch 254. In addition, FIG. 2 also illustrates a plurality of future workload batches 260 such as a first future batch 261, a second future batch 262, a third future batch 263, an Nth future batch 264, etc. In the example of FIG. 2, N quantity of future batches are illustrated. One skilled in the art would know that N is any integer quantity.

In one example, the plurality of future workload batches 260 are synchronously inputted into the plurality of slices via the common databus 201 after the plurality of current workload batches 250 have been completely executed. In one example, synchronously inputted implies that a single state transition or a single trigger results in all slices of the plurality of slices provided an updated input.

In FIG. 2, each slice of the plurality of slices supplies an output coordination signal to indicate completion of the execution of a batch in the slice. For example, the first slice 210 supplies a first output sync signal 211, the second slice 220 supplies a second output sync signal 221, the third slice 230 supplies a third output sync signal 231, the Nth slice 240 supplies an Nth output sync signal 241, etc. In one example, the first output sync signal 211, the second output sync signal 221, the third output sync signal 231, the Nth output sync signal 241, etc. are provided to a coordination module 270. In the example of FIG. 2, N quantity of output sync signals are illustrated. One skilled in the art would know that N is any integer quantity.

In one example, the coordination module 270 generates a global coordination signal 271 with a global status which depends on the first output sync signal 211, the second output sync signal 221, the third output sync signal 231, the Nth output sync signal 241, etc. In one example, the global status of the global coordination signal 271 transitions from a first global state to a second global state when each status of the first output sync signal 211, the second output sync signal 221, the third output sync signal 231, the Nth output sync signal 241, etc. has transitioned to an active state. For example, the first global state indicates an unsynchronized global state. For example, the second global state indicates a synchronized global state. That is, a transition from the first global state to the second global state is a transition from being unsynchronized to being synchronized for the plurality of slices.

In one example, each transition of the global status of the global coordination signal 271 occurs synchronously. That is, each slice may operate with global coordination. In one example, the first slice 210, the second slice 220, the third slice 230, the Nth slice 240, etc. operate synchronously with respect to batch execution. That is, global coordination ensures data coherency over all slices but with increased execution latency due to the intrinsic need for global coordination among all slices.

In one example, the global coordination signal 271 is transported to the common databus 201. In one example, the global coordination signal 271 governs a transition from the plurality of current workload batches 250 to the plurality of future workload batches 260 as input to the plurality of slices. For example, the transition from the plurality of current workload batches 250 to the plurality of future workload batches 260 operates synchronously.

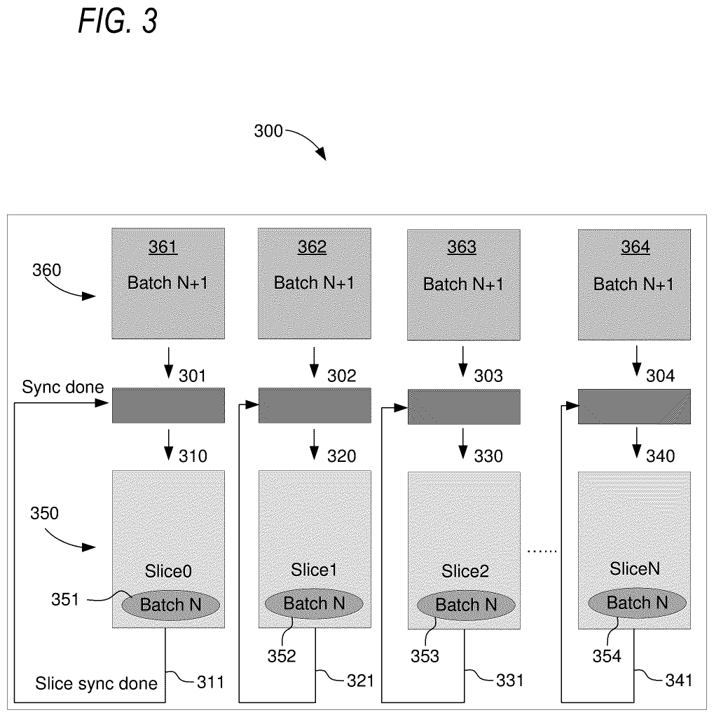

FIG. 3 illustrates an example distributed information processing system 300 with a plurality of slices. In one example, a slice is a processing unit or a processing core. In one example, the distribution information processing system 300 may be a graphical processing unit (GPU) or a central processing unit (CPU). In one example, the plurality of slices includes a first slice 310, a second slice 320, a third slice 330, a Nth slice 340, etc. In general, the distributed information processing system 300 may have an arbitrary quantity of slices. The plurality of slices may include a plurality of memory units. In one example, each slice includes a memory unit. In another example, each slice of a plurality of slices may be coupled to one or more memory units of a plurality of memory units, wherein the plurality of memory units is shared among the plurality of slices.

Each slice of the plurality of slices uses one of a plurality of dedicated databuses to transport messages and data. For example, the first slice 310 may have a first dedicated databus 301, the second slice 320 may have a second dedicated databus 302, the third slice 330 may have a third dedicated databus 303, the Nth slice 340 may have an Nth dedicated databus 304, etc. In one example, the distributed information processing system 300 may have a common databus (not shown) interconnecting the plurality of slices together. In the example of FIG. 3, N quantity of slices and Nth quantity of dedicated databus are illustrated. One skilled in the art would know that N is any integer quantity.

FIG. 3 also illustrates a plurality of current workload batches 350 including a first current batch 351, a second current batch 352, a third current batch 353, an Nth current batch 354, etc. In one example, the first slice 310 is operating with the first current batch 351, the second slice 320 is operating with the second current batch 352, the third slice 330 is operating with the third current batch 353, the Nth slice 340 is operating with the Nth current batch 354. In the example of FIG. 3, N quantity of current batches are illustrated. One skilled in the art would know that N is any integer quantity. In one example, the plurality of current workload batches 350 is stored in a plurality of memory units.

In addition, FIG. 3 also illustrates a plurality of future workload batches 360 such as a first future batch 361, a second future batch 362, a third future batch 363, an Nth future batch 364, etc. For example, each future workload batch of the plurality of future workload batches 360 is asynchronously inputted into each slice of the plurality of slices via the plurality of dedicated databuses after each current workload batch of the plurality of current workload batches 350 has been individually executed. In one example, asynchronously inputted implies that multiple, independent state transitions or multiple triggers result in each slice of the plurality of slices provided an updated input independently and asynchronously. In the example of FIG. 3, N quantity of future batches are illustrated. One skilled in the art would know that N is any integer quantity. In one example, the plurality of future workload batches 360 is stored in a plurality of external memory units. In one example, the plurality of external memory units is not the same as the plurality of memory units that stores the plurality of current workload batches 350.

In FIG. 3, each slice of the plurality of slices supplies a local output coordination signal to indicate completion of the execution of a batch in the slice. For example, the first slice 310 supplies a first local output sync signal 311, the second slice 320 supplies a second local output sync signal 321, the third slice 330 supplies a third local output sync signal 331, the Nth slice 340 supplies an Nth local output sync signal 341, etc. In the example of FIG. 3, N quantity of local output sync signals are illustrated. One skilled in the art would know that N is any integer quantity.

In one example, the first local output sync signal 311 is provided to the first dedicated databus 301, the second local output sync signal 321 is provided to the second dedicated databus 302, the third local output sync signal 331 is provided to the third dedicated databus 303, the Nth local output sync signal 341 is provided to the Nth dedicated databus 304, etc.

In one example, the first local output sync signal 311, the second local output sync signal 321, the third local output sync signal 331, the Nth local output sync signal 341 are all asynchronous with respect to each other. In one example, the first local output sync signal 311 has a first local status, the second local output sync signal 321 has a second local status, the third local output sync signal 331 has a third local status, the Nth local output sync signal 341 has a Nth local status, etc. In the example of FIG. 3, N quantity of local status are illustrated. One skilled in the art would know that N is any integer quantity.

In one example the transition of the first local status from an unsynchronized state to a synchronized state when the first slice 310 completes execution of a batch within the first slice 310. In one example the transition of the second local status from an unsynchronized state to a synchronized state when the second slice 320 completes execution of a batch within the second slice 320. In one example the transition of the third local status from an unsynchronized state to a synchronized state when the third slice 330 completes execution of a batch within the third slice 330. In one example the transition of the Nth local status from an unsynchronized state to a synchronized state when the Nth slice 340 completes execution of a batch within the Nth slice 340.

In one example, each transition of each local status for each local output sync signal occurs asynchronously. That is, each slice may operate with local coordination. That is, each slice may complete execution of a batch within its slice and operate with local coordination, rather than global coordination. In one example, the first slice 310, the second slice 320, the third slice 330, the Nth slice 340, etc. operate asynchronously with respect to batch execution. In one example, a slice X operates on its batch (i.e., batch X) asynchronously with respect to another slice (e.g., slice Y) which operates on its batch (i.e., batch Y). In this example, slice X and slice Y are two different slices in the plurality of slices.

In one example, operating each slice of the plurality of slices with a local output coordination signal improves the timing performance of the distributed information processing system 300 by reducing execution latency. That is, timing performance may be improved by ensuring data coherency within a slice rather than over all slices. In one example, execution latency may be reduced by employing local coordination within each slice rather than global coordination among all slices.

In one example, local coordination, rather than global coordination, is feasible when processing applications (e.g., graphical processing) perform mostly local (e.g., in pixel) processing with local memory access, rather than global memory access. For example, the data producers and data consumers in a given slice may be independent of data producers and data consumers in other slices. That is, batch execution for each slice may proceed asynchronously and independently from batch executions for other slices which reduces timing performance overhead.

In one example, the data producers and data consumers in each slice require local coordination and data coherency only within that slice. In one example, timing skew in batch execution within a slice is much less than across multiple slices which results in improved timing performance using local coordination rather than global coordination.

In one example, local coordination may insert a local event tag in the sequence of operations to ensure that all data producers have written data into a slice memory, buffer memory or main memory prior to any data consumer commence a read operation on the sequence of operations.

In one example, local coordination executed by a data producer may execute a write request sequence as follows:
{write request in batch0->local event tag->write request in batch1}.

In one example, local coordination executed by a data consumer may execute a read request sequence as follows:
{read request in batch0->local event tag->read request in batch1}.

In one example, when a local coordination node (e.g., a slice memory) receives the local event tag, it may push back all subsequent requests from a same path until the following conditions are met:
1. All previous requests in the same path are completed.
2. The local event tag is received in other paths within the same slice and requests in those other paths are completed.

In one example, requests in a same path are completed when all write data are visible in slice memory and all read requests get data returned. In one example, local coordination for a distributed information processing system may be used in many scenarios such as rendering to texture, slice memory sub pass, local data coherency between compute kernels, machine learning, etc.

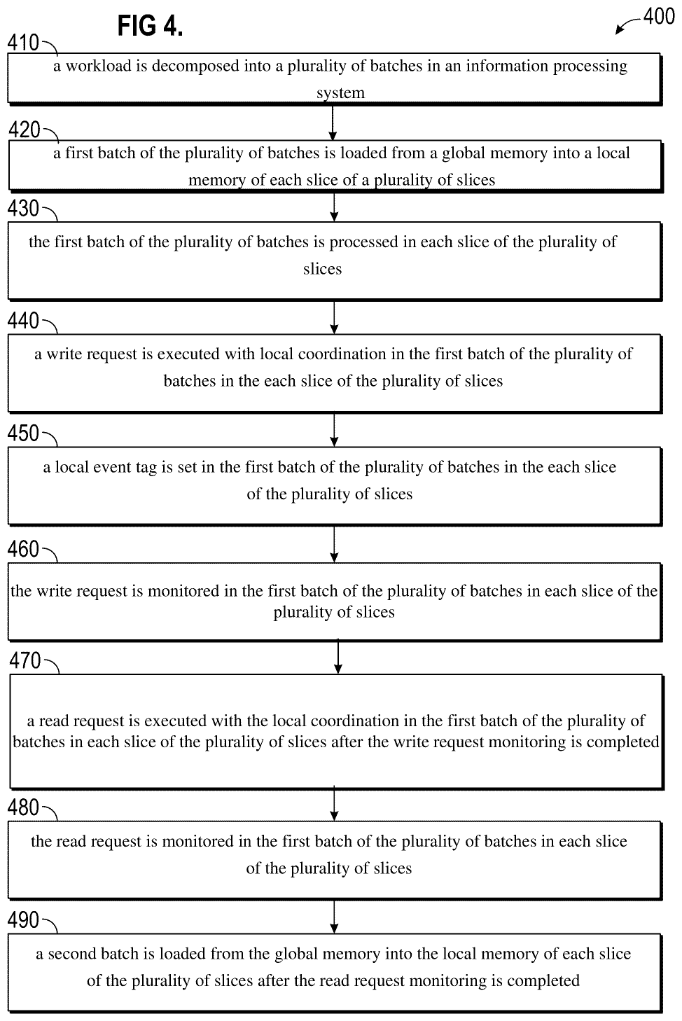

FIG. 4 illustrates an example flow diagram 400 for executing local coordination in a distributed information processing system. In block 410, a workload is decomposed into a plurality of batches in an information processing system. In one example, the plurality of batches includes a first batch, a second batch, a third batch, etc. until an Nth batch. For example, the plurality of batches is organized to be executed in sequential order. In one example, the plurality of batches is stored in a global memory of the information processing system.

In block 420, a first batch of the plurality of batches is loaded from a global memory into a local memory of each slice of a plurality of slices in a distributed information processing system. In one example, the first batch from the global memory is loaded into each local memory using a dedicated databus for each slice.

In block 430, the first batch of the plurality of batches is processed in each slice of the plurality of slices. In one example, the each slice includes a plurality of data producers. In one example, the each slice includes a plurality of data consumers. In one example, each data producer of the plurality of data producers provides data to one or more data consumers of the plurality of data consumers. In one example, the processing step may include operations such as, but not limited to, mathematical operations, sorting operations, storage operations, retrieval operations, logical operations, symbolic operations, etc.

In block 440, a write request is executed with local coordination in the first batch of the plurality of batches in the each slice of the plurality of slices. In one example, the write request is executed by a data producer of a plurality of data producers. In one example, the write request in each slice of the plurality of slices is executed asynchronously with respect to other slices of the plurality of slices.

In block 450, a local event tag is set in the first batch of the plurality of batches in the each slice of the plurality of slices. In one example, each slice of the plurality of slices supplies a local output coordination signal to indicate completion of the execution of a batch in the slice.

In block 460, the write request is monitored in the first batch of the plurality of batches in each slice of the plurality of slices. In one example, the monitoring is performed until all previous write requests in a path are completed. In one example, the monitoring is performed until the path has a verified receipt of the local event tag. In one example, the monitoring is performed until the write request in the first batch of the plurality of batches is completed. In one example, the monitoring is performed until two or more of the following occur: a) all previous write requests in a path are completed; b) the path has a verified receipt of the local event tag; c) the write request in the first batch of the plurality of batches is completed. In one example, the monitoring in each slice of the plurality of slices is performed asynchronously with respect to other slices of the plurality of slices.

In block 470, a read request is executed with the local coordination in the first batch of the plurality of batches in each slice of the plurality of slices after the write request monitoring is completed. In one example, the read request is executed by a data consumer of the plurality of data consumers. In one example, each data consumer of the plurality of data consumers receives data from one or more data producers of the plurality of data producers. In one example, the read request in each slice of the plurality of slices is performed asynchronously with respect to other slices of the plurality of slices.

In block 480, the read request is monitored in the first batch of the plurality of batches in each slice of the plurality of slices. In one example, the monitoring is performed until all previous read requests in a path are completed. In one example, the monitoring is performed until the path has a verified receipt of the local event tag. In one example, the monitoring is performed until the read request in the first batch of the plurality of batches is completed. In one example, the monitoring is performed until two or more of the following occur: a) all previous read requests in a path are completed; b) the path has a verified receipt of the local event tag; c) the read request in the first batch of the plurality of batches is completed.

In block 490, a second batch is loaded from the global memory into the local memory of each slice of the plurality of slices in the distributed information processing system after the read request monitoring is completed. In one example, the second batch from the global memory is loaded into each local memory using the dedicated databus for each slice.

In one aspect, one or more of the steps in FIG. 4 may be executed by one or more processors which may include hardware, software, firmware, etc. In one aspect, one or more of the steps in FIG. 4 may be executed by one or more processors which may include hardware, software, firmware, etc. The one or more processors, for example, may be used to execute software or firmware needed to perform the steps in the flow diagram of FIG. 4. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a plurality of slices, wherein each slice of the plurality of slices is configured for distributed information processing; and
a plurality of dedicated databuses, wherein each slice of the plurality of slices is coupled to one of the plurality of dedicated databuses and each slice of the plurality of slices is configured for local coordination for the distributed information processing.

2. The apparatus of claim 1, wherein the each slice of the plurality of slices includes a memory unit.

3. The apparatus of claim 2, wherein the each slice of the plurality of slices is a processing unit.

4. The apparatus of claim 2, further comprising a plurality of current workload batches.

5. The apparatus of claim 4, wherein each of the plurality of current workload batches is stored within the memory unit of the each slice of the plurality of slices.

6. The apparatus of claim 5, wherein each of the plurality of current workload batches is different from another of the plurality of current workload batches.

7. The apparatus of claim 5, wherein at least two of the plurality of current workload batches are the same.

8. The apparatus of claim 2, further comprising a plurality of external memory units configured to store a plurality of future workload batches, wherein each of the plurality of slices is associated with one of the plurality of future workload batches.

9. The apparatus of claim 1, further comprising a plurality of data producers, wherein each of the plurality of data producers is configured to execute a write request in each of the plurality of slices.

10. The apparatus of claim 1, further comprising a plurality of data consumers, wherein each of the plurality of data consumers is configured to execute a read request in each of the plurality of slices.

11. A method for implementing slice coordination, the method comprising:
executing a write request with local coordination in a first batch of a plurality of batches in each slice of a plurality of slices;
setting a local event tag in the first batch of the plurality of batches in the each slice of the plurality of slices;
monitoring the write request in the first batch of the plurality of batches in the each slice of the plurality of slices;
executing a read request with the local coordination in the first batch of the plurality of batches in the each slice of the plurality of slices after monitoring the write request is completed; and
monitoring the read request in the first batch of the plurality of batches in the each slice of the plurality of slices.

12. The method of claim 11, wherein the write request in the each slice of the plurality of slices is executed asynchronously with respect to other slices of the plurality of slices.

13. The method of claim 12, further comprising the each slice of the plurality of slices suppling a local output coordination signal to indicate completion of the execution of a batch in the each slice of the plurality of slices.

14. The method of claim 13, wherein monitoring the write request is performed until all previous write requests in a path are completed.

15. The method of claim 13, wherein monitoring the write request is performed until a path has a verified receipt of the local event tag.

16. The method of claim 13, wherein monitoring the write request is performed until the write request in the first batch of the plurality of batches is completed.

17. The method of claim 13, wherein monitoring the write request is performed until two or more of the following occur: a) all previous write requests in a path are completed; b) the path has a verified receipt of the local event tag; c) the write request in the first batch of the plurality of batches is completed.

18. The method of claim 11, wherein the read request in the each slice of the plurality of slices is executed asynchronously with respect to other slices of the plurality of slices.

19. The method of claim 18, wherein monitoring the read request is performed until all previous read requests in a path are completed.

20. The method of claim 18, wherein monitoring the read request is performed until a path has a verified receipt of the local event tag.

21. The method of claim 18, wherein monitoring the read request is performed until the read request in the first batch of the plurality of batches is completed.

22. The method of claim 18, wherein monitoring the read request is performed until two or more of the following occur: a) all previous read requests in a path are completed; b) the path has a verified receipt of the local event tag; c) the read request in the first batch of the plurality of batches is completed.

23. An apparatus for implementing slice coordination, the apparatus comprising:
means for executing a write request with local coordination in a first batch of a plurality of batches in each slice of a plurality of slices;
means for setting a local event tag in the first batch of the plurality of batches in the each slice of the plurality of slices;
means for monitoring the write request in the first batch of the plurality of batches in the each slice of the plurality of slices;
means for executing a read request with the local coordination in the first batch of the plurality of batches in the each slice of the plurality of slices after monitoring the write request is completed; and
means for monitoring the read request in the first batch of the plurality of batches in the each slice of the plurality of slices.

24. The apparatus of claim 23, wherein the means for executing the write request is configured to execute asynchronously with respect to other slices of the plurality of slices, and wherein the means for executing the read request is configured to execute asynchronously with respect to the other slices of the plurality of slices.

25. The apparatus of claim 24, wherein the means for monitoring the write request is configured to perform monitoring until one or more of the following occur: a) all previous write requests in a path are completed; b) the path has a verified receipt of the local event tag; c) the write request in the first batch of the plurality of batches is completed.

26. The apparatus of claim 24, wherein the means for monitoring the read request is configured to perform monitoring until one or more of the following occur: a) all previous read requests in a path are completed; b) the path has a verified receipt of the local event tag;
c) the read request in the first batch of the plurality of batches is completed.

27. A non-transitory computer-readable medium storing computer executable code, operable on a device comprising at least one processor and at least one memory coupled to the at least one processor, wherein the at least one processor is configured to implement slice coordination, the computer executable code comprising:
instructions for causing a computer to execute a write request with local coordination in a first batch of a plurality of batches in each slice of a plurality of slices;
instructions for causing the computer to set a local event tag in the first batch of the plurality of batches in the each slice of the plurality of slices;
instructions for causing the computer to monitor the write request in the first batch of the plurality of batches in the each slice of the plurality of slices;
instructions for causing the computer to execute a read request with the local coordination in the first batch of the plurality of batches in the each slice of the plurality of slices after monitoring the write request is completed; and
instructions for causing the computer to monitor the read request in the first batch of the plurality of batches in the each slice of the plurality of slices.

28. The non-transitory computer-readable medium of claim 27, further comprising instructions for causing the computer to execute the write request asynchronously with respect to other slices of the plurality of slices, and to execute the read request asynchronously with respect to the other slices of the plurality of slices.

29. The non-transitory computer-readable medium of claim 28, further comprising instructions for causing the computer to monitor the write request until one or more of the following occur: a) all previous write requests in a path are completed; b) the path has a verified receipt of the local event tag; c) the write request in the first batch of the plurality of batches is completed.

30. The non-transitory computer-readable medium of claim 28, further comprising instructions for causing the computer to monitor the read request until one or more of the following occur: a) all previous read requests in a path are completed; b) the path has a verified receipt of the local event tag; c) the read request in the first batch of the plurality of batches is completed.
